(19) United States
(12) Patent Application Publication
(10) Pub. No.: US 2010/0229798 A1
(43) Pub. Date: Sep. 16, 2010

(54) Pets all in one

(76) Inventor: Daisy V. Litchmore, Huntington, NY (US)

Correspondence Address: Daisy V. Litchmore, 17 Leigh Street, Huntington, NY, 11743, US

(21) Appl. No.: 12/381,655

(22) Filed: Mar. 16, 2009

(51) Int. Cl. A01K 1/00

(52) U.S. Cl. 119/28.5; 119/51.01; 119/161

(57) ABSTRACT

Dear Sir or Madam: If this invention is used then the kitchen area of the house will be more comfortable for cats to use and the area will look like
another furnishing of the home. The pets will be able to use the litter and eat their meals and sit on top of the invention and the invention
would not disturb the other furnishings.

### BACKGROUND OF INVENTION

This invention is made to serve as a feeding station for cats and Dogs and it also serves as a litter for cats and a sitting station also while looking like a cabinet or home furnishing similar to a cabinet.

### BRIEF SUMMARY OF THE INVENTION

This invention called, Pets all in one is able to be placed in the kitchen area of the house and serve pets while looking like a home furnishing of a cabinet.

### BRIEF DESCRIPTION OF THE SEVERAL VIEWS OF THE DRAWING

FIG. 1 shows the front view of the invention.

FIG. 2 shows the front view of the invention with the included tray and bowls for feeding the cats and dogs.

FIG. 3 shows the plastic flap at in the side of the invention for pets to go in and out for use of the removeable litter inside.

FIG. 4 is a view of the rear of the invention with a display of the removable backing of the cabinet to remove the litter.

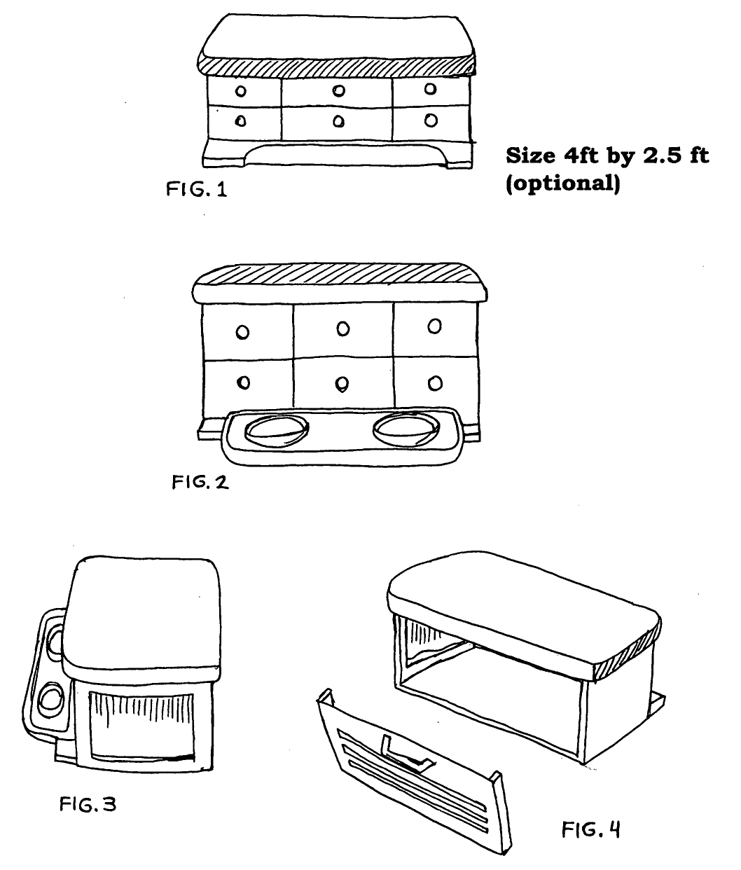

### DETAILED DESCRIPTION OF THE INVENTION

This invention called Pets all in one is thought best to be made from plastic factory molds of the sturdiest plastics available and the simulated draws will not truly open but be as decoration.

1. If this idea is accepted it would be a beautiful way to decorate any kitchen of any cat owner or dog owners' home.

2. Without the use of this idea the pets feeding station would be easily noticeable, but this lovingly makes it a uniform home decoration with all the other home furnishings.
